(19) United States
(12) Patent Application Publication
(10) Pub. No.: US 2020/0070050 A1
(43) Pub. Date: Mar. 5, 2020

(54) GAME DEVICE, GAME CONTROL METHOD, AND GAME PROGRAM

(71) Applicant: SHARP KABUSHIKI KAISHA, Sakai City (JP)

(72) Inventor: YUUKI DOI, Sakai City (JP)

(21) Appl. No.: 16/549,429

(22) Filed: Aug. 23, 2019

(30) Foreign Application Priority Data
Aug. 31, 2018 (JP) 2018-163383

(51) Int. Cl. A63F 13/46; A63F 13/2145; G06F 3/0354

(52) U.S. Cl. CPC A63F 13/46; G06F 3/03545; A63F 13/2145

(57) ABSTRACT

A game device includes: a problem submitter that submits a problem with regard to a graphic sub-divided into a plurality of zones; an input information acquirer that acquires color and numeric value information associated with a pen selected by a user from among a plurality of pens; a color judger that judges whether or not the color associated with the pen is identical to the color associated with a zone adjacent to a zone selected by the pen; a numeric value judger that judges whether or not a total numeric value that is the sum of numeric values associated with all of the respective zones selected by the pen, matches a target numeric value associated with the graphic; and a correctness judger that judges correctness with regard to the problem, based on judgement results from the color judger and from the numeric value judger.

### BACKGROUND OF THE INVENTION

### Field of the Invention

The present invention relates to a game device, a game control method, and a game program.

### Description of the Background Art

Game devices that activate brain functions to prevent dementia etc. have been proposed in recent years. Japanese Unexamined Patent Application Publication No. 2002-297779, for example, discloses a game device that enhances the training effect for dementia prevention etc. by playing multiple types of games on one screen.

More specifically, in the game device of Japanese Unexamined Patent Application Publication No. 2002-297779, a game image of the calculation game and a game image of a whack-a-mole game are displayed on two display areas respectively on the left and right sides of the display screen, and each game simultaneously starts and progresses. The performance (proficiency level and degree of concentration) of the player to perform one game is also reflected in the difficulty level of the other game based on the player's overall ability in each game.

Though playing conventional game devices may allow expecting better performance (proficiency level and degree of concentration), improving calculation ability and planning ability is difficult. Calculation ability and planning ability are not only important for preventing dementia but are also indispensable skills for daily activities and enhancing these functions is essential especially for a future aging society.

In view of the above circumstances, an object of the present invention is to provide a game device, a game control method, and a game program capable of simultaneously improving calculation ability and planning ability.

### SUMMARY OF THE INVENTION

A game device according to one aspect of the present invention includes a problem submitter that submits a problem with regard to a graphic sub-divided into a plurality of zones; a pen information acquirer that acquires attribute information and numeric value information associated with a pen selected by a user from among a plurality of pens; an attribute judger that judges whether or not the attribute information associated with the pen and acquired by the pen information acquirer is identical to the attribute information associated with a second zone adjacent to a first zone selected by the pen in the graphic; a numeric value judger that judges whether or not a total numeric value that is the sum of numeric values associated with all of the respective zones selected by the pen, matches a target numeric value associated with the graphic; and a correctness judger that judges correctness with regard to the problem, based on judgement results from the attribute judger and judgement results from the numeric value judger.

A game control method according to another aspect of the present invention including: submitting a problem with regard to a graphic sub-divided into a plurality of zones; acquiring attribute information and numeric value information associated with a pen selected by a user from among a plurality of pens; judging whether or not the attribute information associated with the pen and acquired in the acquisition of the pen information is identical to the attribute information associated with a second zone adjacent to a first zone selected by the pen in the graphic; judging whether or not a total numeric value that is the sum of the numeric values associated with all of the respective zones selected by the pen, matches a target numeric value associated with the graphic; and judging correctness with regard to the problem, based on judgement results from the attribute judging and judgement results from the numeric value judging.

A game program according to another aspect of the present invention causes a computer to execute: submitting a problem with regard to a graphic sub-divided into a plurality of zones; acquiring attribute information and numeric value information associated with a pen selected by a user from among a plurality of pens; judging whether or not the attribute information associated with the pen and acquired in the acquisition of the pen information is identical to the attribute information associated with a second zone adjacent to a first zone selected by the pen in the graphic; judging whether or not a total numeric value that is the sum of the numeric values associated with all of the respective zones selected by the pen, matches a target numeric value associated with the graphic; and judging correctness with regard to the problem, based on judgement results from the attribute judging and judgement results from the numeric value judging.

The present invention is capable of simultaneously improving calculation ability and planning ability.

### BRIEF DESCRIPTION OF THE DRAWINGS

FIG. 1 is a block diagram showing a configuration of the game device according to an embodiment of the present invention;

FIG. 2A is a drawing showing an example of a level selection screen shown on a display according to an embodiment of the present invention;

FIG. 2B is a drawing showing an example of a start screen shown on the display according to an embodiment of the present invention;

FIG. 2C is a drawing showing an example of a game screen shown on the display according to an embodiment of the present invention;

FIG. 2D is a drawing showing an example of a game screen shown on the display according to an embodiment of the present invention;

FIG. 2E is a drawing showing an example of a game screen shown on the display according to an embodiment of the present invention;

FIG. 2F is a drawing showing an example of a game screen shown on the display according to an embodiment of the present invention;

FIG. 2G is a drawing showing an example of a game screen shown on the display according to an embodiment of the present invention;

FIG. 2H is a drawing showing an example of a game screen shown on the display according to an embodiment of the present invention;

FIG. 3 is a table showing an example of problem information stored in the storage portion of the game device according to an embodiment of the present invention;

FIG. 4A is a drawing showing an example of a graphic in level 1 in the game device according to an embodiment of the present invention;

FIG. 4B is a drawing showing an example of a graphic in level 4 in the game device according to an embodiment of the present invention;

FIG. 5A is a drawing showing an example of a graphic in level 4 in the game device according to an embodiment of the present invention;

FIG. 5B is a table showing an example of an adjacent zone list stored in the storage portion of the game device according to an embodiment of the present invention;

FIG. 6 is a drawing showing the minimum zone segment of the graphic in the game device according to an embodiment of the present invention;

FIG. 7 is a table showing an example of numeric values and color information associated with a pen stored in a storage portion of the game device according to an embodiment of the present invention;

FIG. 8 is a flow chart for describing an example of the procedure for the game control process in the game device according to an embodiment of the present invention;

FIG. 9 is a flowchart for describing an example of the procedure of the game control process in the game device according to an embodiment of the present invention, and

FIG. 10 is a drawing showing an example of a game screen shown on the display according to an embodiment of the present invention.

### DESCRIPTION OF THE PREFERRED EMBODIMENTS

The embodiments of the present invention are hereinafter described while referring to the accompanying drawings. The following embodiments are merely specific examples of the present invention and are not intended to limit the technical scope of the present invention.

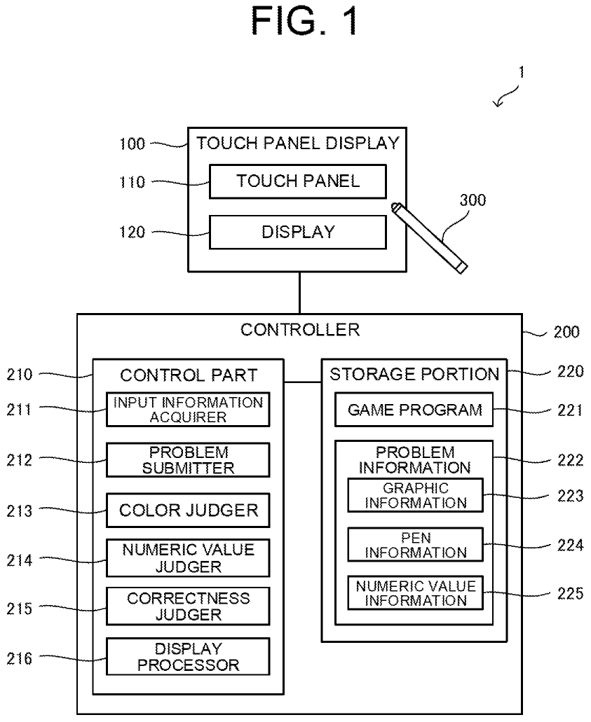

A game device 1 according to the embodiment of the present invention as shown in FIG. 1 contains a touch panel display 100 and a controller 200. The controller 200 is a computer connected to the touch panel display 100 to control the touch panel display 100.

The touch panel display 100 contains a touch panel 110 and a display 120. The touch panel 110 may be an electro-static capacitive touch panel, or may be a pressure-sensitive or infrared blocking touch panel. In other words, any device may serve as the touch panel 110 provided that the device is capable of correctly accepting the operation input from the user such as a touch operation by the user's fingers or by a touch pen. The touch panel 110 is installed on the display 120. The display 120 is for example, a liquid crystal display. However, the display 120 is not limited to a liquid crystal display and may be a light emitting diode (LED) display or an organic electro-luminescence (EL) display. The touch panel display 100 may be a device such as a computer, tablet terminal, or smartphone.

A description of how to play the game on the game device 1 is given next. Briefly, in this game, on a graphic sub-divided (compartmented) into a plurality of zones, the user selects (colors-in) applicable zones by using pens of a plurality of colors (for example, four colors) so as not to color-in adjacent zones of the same color; and also sums the numeric value assigned to each pen to reach a matching target numeric value. A specific procedure for an actual game play method is described next.

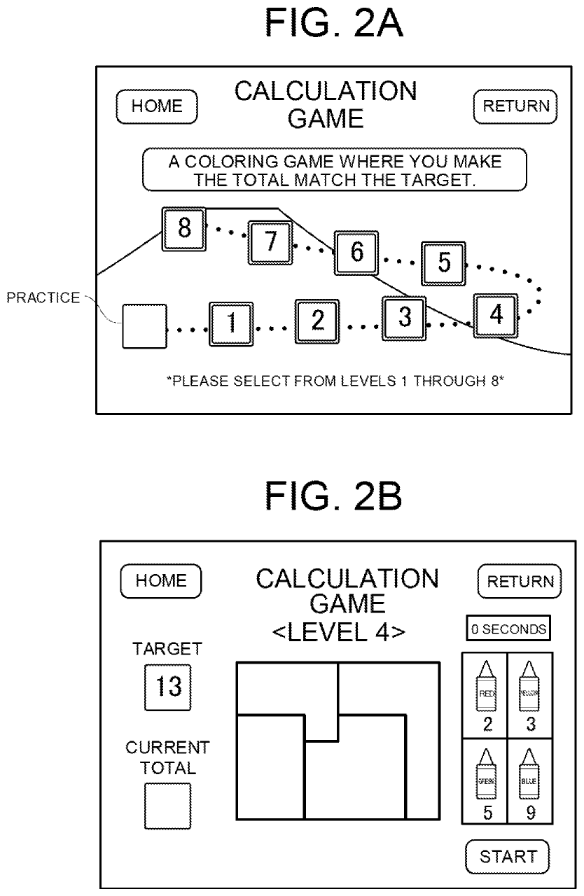

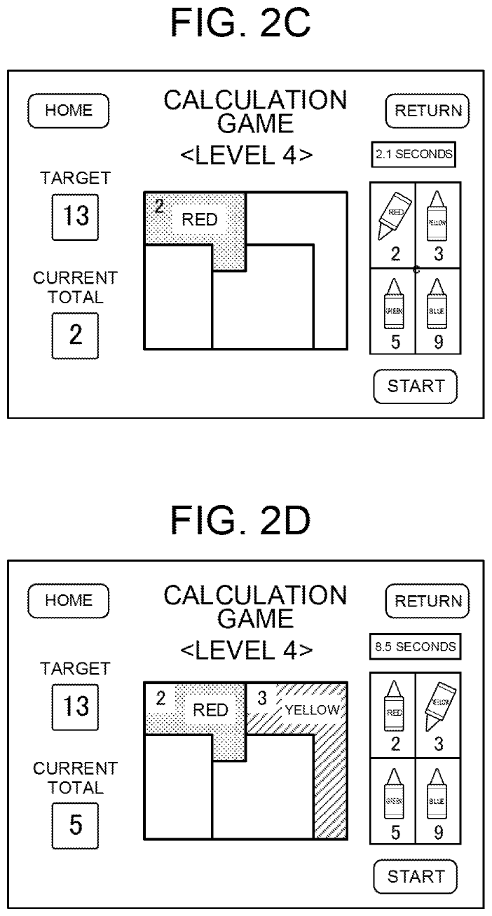

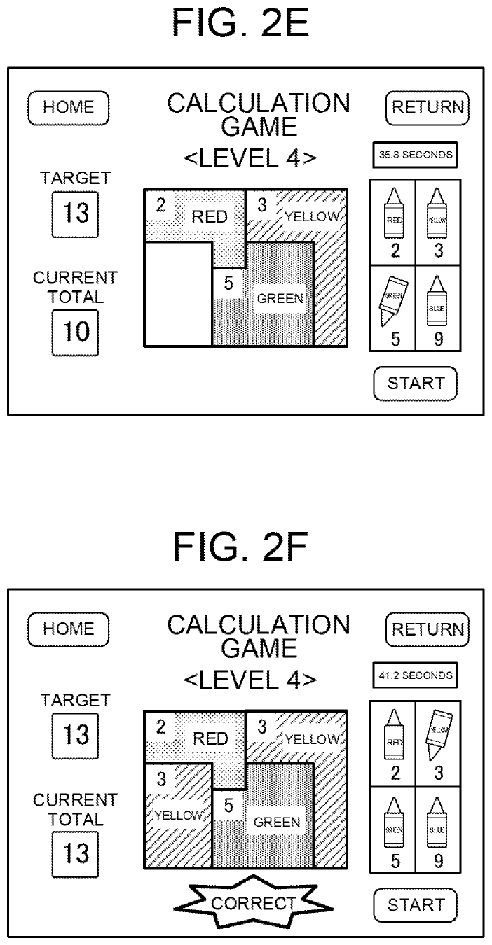

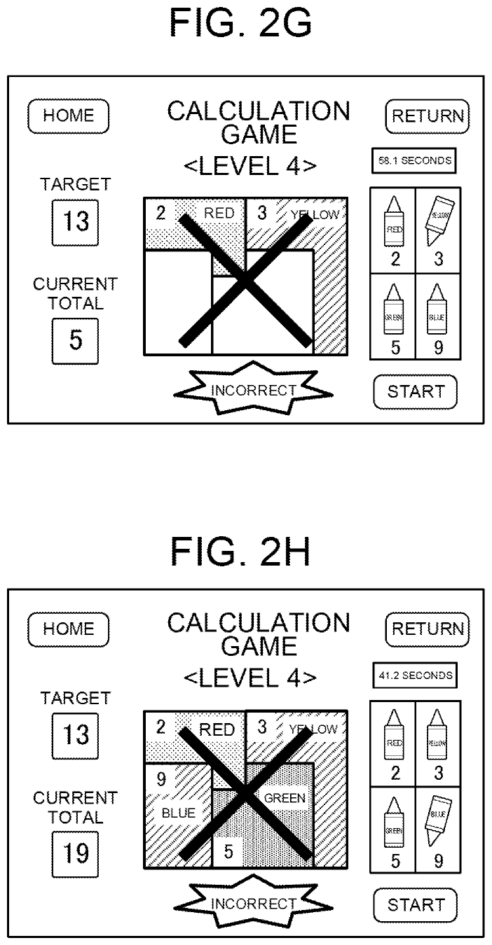

First of all, the level select screen shown in FIG. 2A appears on the display 120 of the game device 1 when the user (game player) turns on the power to the game device 1. Difficulty levels are registered in the game device 1, from the lowest level game of difficulty level 1 to the highest level game of difficulty level 8 according to the difficulty of the game (problem). The user selects the desired level of difficulty on the level select screen.

When the user for example, selects level 4, a start screen as shown in FIG. 2B appears on the display 120. The start screen displays a plurality of sub-divided zones (here four zones) each having a rectangular graphic shown in the default color (here white color); and four pens each assigned with a numeric value and color; and a target (correct) numeric value (here, “13”). For example, a numeric value “2” is assigned to the red pen, a numeric value “3” is assigned to the yellow pen, a numeric value “5” is assigned to the green pen, and a numeric value “9” is assigned to the blue pen. Further, information on the number and position of zones contained in the graphic; information on the pen color and numeric value, and information on the numeric value of the target are mutually associated and registered beforehand according to the game level.

When the user selects the “start” button on the start screen the game starts, and the timer starts counting the time. The elapsed time is displayed on the display 120. When the game starts, the user selects one desired pen from the four colored pens, and selects one desired zone from among the zones. When the user for example, selects the red pen and selects the upper left zone, the applicable zone is colored red and the numeric value “2” is displayed as shown in FIG. 2C. In other words, “red” and “2” are associated with the applicable zone.

The user next selects one desired pen from the four colored pens and selects one desired zone from the other white-colored zones (non-selected zones). For example, when the user selects the yellow pen and selects the right upper zone, since the zone adjacent to the selected zone is colored red and is different from the “yellow” pen color, the applicable zone is colored yellow and a numeric value “3” is displayed as shown in FIG. 2D. In other words, “yellow” and “3” are associated with the applicable zone. Also, the current value (here “5”) that is the total for all the numeric values associated with the respective selected zones is shown on the display 120.

In the same way, when the user for example, selects the green pen and selects the zone in the lower center, the zones adjacent to the selected zone are colored red and yellow and are different from the “green” pen color so that as shown in FIG. 2E, the applicable zone is colored in green and a numeric value “5” is displayed. The current total numeric value (here, “10”) is shown on the display 120.

In the same way, when the user for example, selects the yellow pen and selects the zone in the lower left, the zones adjacent to the selected zone are red and green which are different from the “yellow” pen color so that as shown in FIG. 2F, the applicable zone is colored yellow and the numeric value “3” is displayed. Also, the current total numeric value (here, “13”) is displayed in the display 120. In this case, the total numeric value matches the target numeric value so that a “Correct” or “O” appears in the display 120. Also, the user may be notified with information (message, voice) about the correct status.

Here, “Incorrect” is displayed when the color associated with the zone selected by the user is the same as the color associated with the zone adjacent to the applicable zone. For example, as shown in FIG. 2G, when the user selects yellow pen and selects the zone in the lower center in a state with the upper left zone colored red and the upper right zone is colored yellow, the color “yellow” in the upper right zone adjacent to the selected zone and the pen color “yellow” are the same so that “Incorrect” or “x” appears on the display 120. Also, the user may be notified with information (message, voice) about the incorrect (wrong) status.

Also, even if the all the adjacent zones are mutually different colors, “Incorrect” appears on the display 120 when the total numeric value does not match the target numeric value. For example, when the user selects the blue pen and selects the lower left zone in the state shown in FIG. 2E, the zones adjacent to the selected zone are a red and green color as shown in FIG. 2H and therefore different from the “blue” pen color so that the applicable zone is colored blue and a numeric value “9” is displayed. However, the total numeric value is “19” and does not match the target numeric value “13” so that “Incorrect” appears on the display 120. In the event of an incorrect result, the pen selection and the zone can be made again.

Playing the game in this way by coloring in a plurality of zones with four colored pens so that adjacent zones are not the same color and by matching the total numeric value with a target numeric value allows improving calculation ability and planning ability.

A specific structure of a controller 200 for playing the game is described next. As shown in FIG. 1, the controller 200 contains a control part 210, and a storage portion 220.

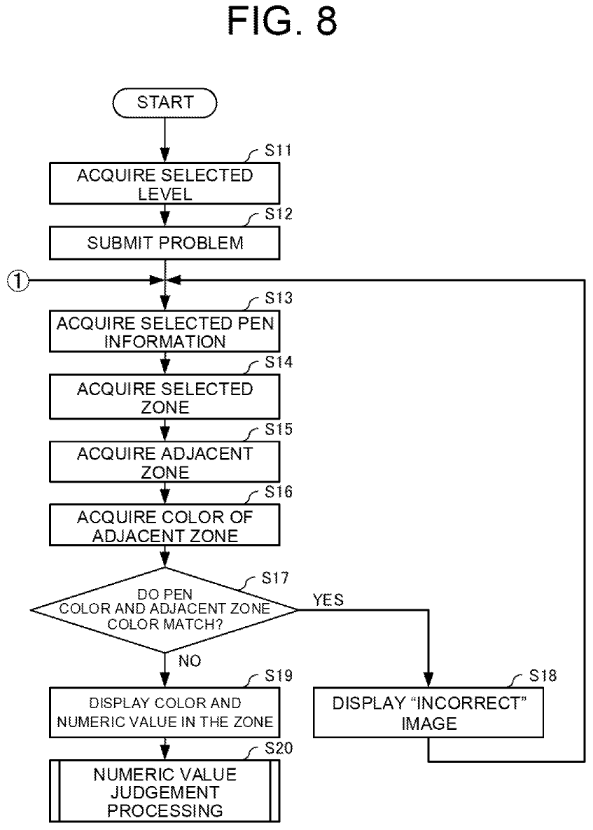

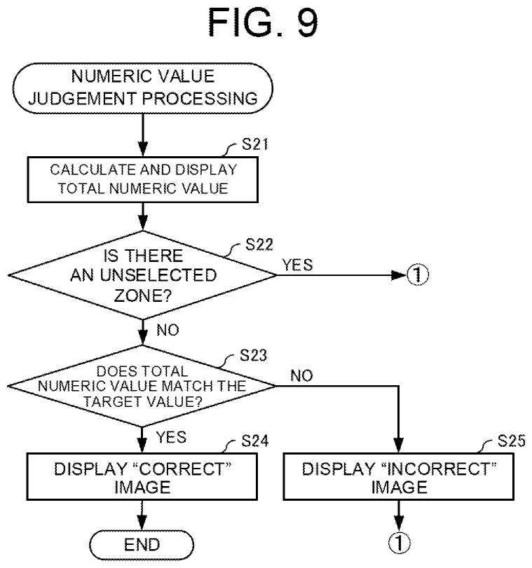

The storage portion 220 is a non-volatile storage portion that contains a semiconductor memory such as a hard disk drive (HDD) or solid state drive (SSD) for storing information of various types. A control program such as a game program 221 to execute the game control process (see FIG. 8 and FIG. 9) described later is stored in the control part 210 in the storage portion 220. The game program 221 for example, is non-temporarily recorded on recording medium such as a USB, CD or DVD (all registered trademarks) capable of being loaded by a computer; and is stored on the storage portion 220 read by a scanning device (not shown in drawing) such as a USB drive, CD drive or DVD drive that is electrically connected to the controller 200. The game program 221 may also be downloaded from an external device via a network and stored in the storage portion 220.

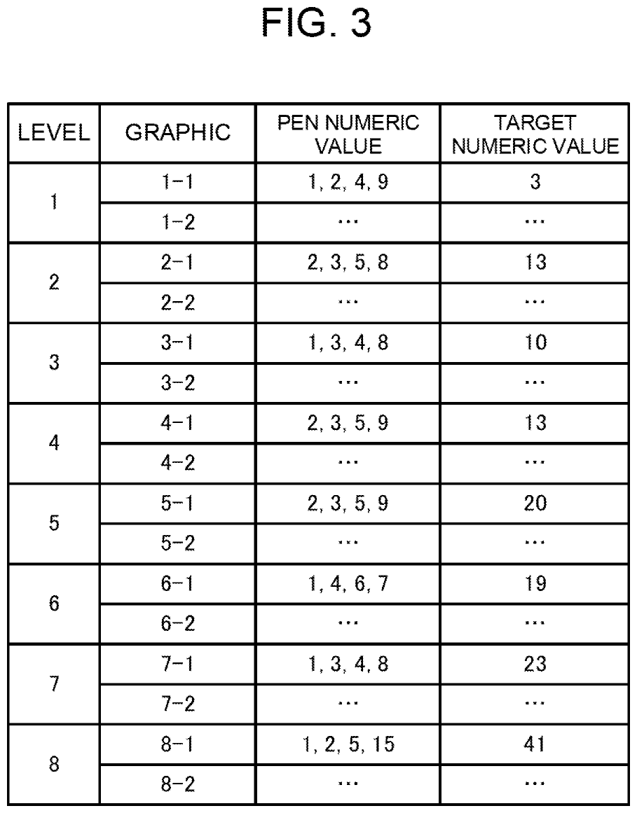

A plurality of problems is stored in the storage portion 220 according to the levels. More specifically, the problem information 222 relating to the problems is stored in the storage portion 220. The graphic information 223, the pen information 224, and the numeric value information 225 mutually associated with each other are stored in the problem information 222. FIG. 3 is a table showing an example of the problem information 222.

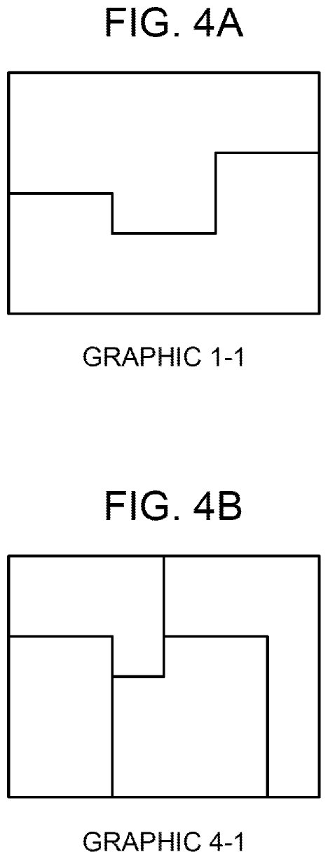

The graphic information 223 includes information about the graphic, identification information for the applicable graphic, placement information for the zone contained in the applicable graphic, and information on the adjacent zones that are adjacent to each zone that are set beforehand according to the game level. Identification information for graphics is registered in the table shown in FIG. 3, and placement information for a zone is associated with the applicable identification information. FIG. 4A for example, shows a graphic associated with the placement information for the zone associated with the graphic 1-1 of level 1; and FIG. 4B shows a graphic associated with the placement information for the zone associated with the graphic 4-1 of level 4. The game is set to include more zones in the graphic as the game level (degree of difficulty) increases. The shape, number and placement of the zones are set beforehand.

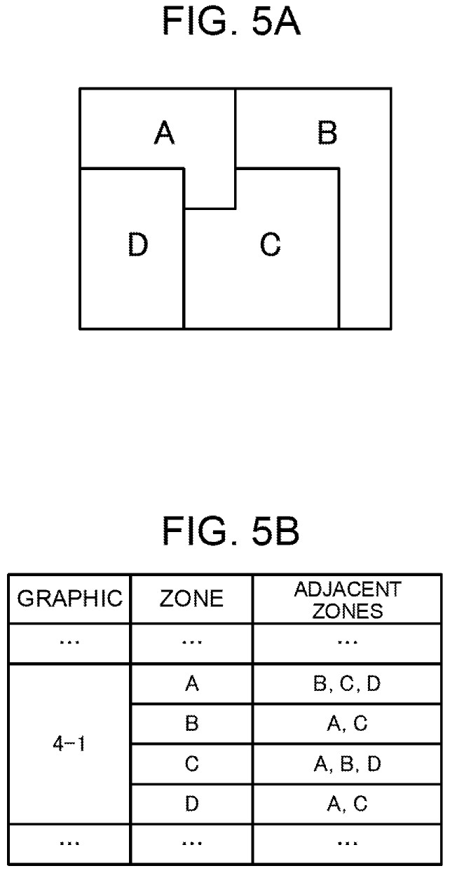

Information about the adjacent zones of each zone is mutually associated with each other in the identity information. FIG. 5B is an adjacent zone list showing adjacent zones associated with graphic 4-1 shown in FIG. 5A. As shown in FIG. 5B, a zone B, a zone C and a zone D are set as adjacent zones for a zone A in the upper left in graphic 4-1; the zone A and the zone C are set as adjacent zones for the zone B in the upper right in graphic 4-1; the zone A, the zone B, and the zone D are set as adjacent zones for the zone C in the lower center in graphic 4-1; and the zone A and the zone C are set as adjacent zones for the zone D at the lower left in graphic 4-1. The adjacent information is stored in the storage portion 220 set beforehand for each graphic.

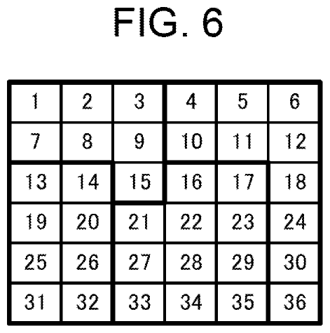

The adjacent zone can be determined by the following method. For example, a judgement is made for each cell as the minimum unit (cells 1 to 36) forming each zone in the graphic (here graphic 4-1) shown in FIG. 6; on whether the cells adjacent at upper/lower/left/right belong to the same zone; and information on adjacent zones is added to the zone where the applicable cell belongs. Methods to determine the adjacent zones are not limited to the above described method.

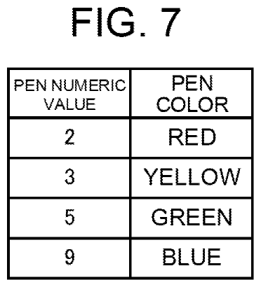

The pen information 224 includes pen image information, color information of the applicable pen, numeric value information assigned to the applicable pen that are set beforehand according to the graphic. The numeric values assigned to the four pens are registered in the table in FIG. 3. The color information for “red”, “yellow”, “green” and “blue” is associated in order with each of the pens matching each numeric value. As shown in FIG. 7, for example, in the pens associated with graphic 4-1 of level 4; “red” is associated with the pen of numeric value “2”, “yellow” is associated with the pen of numeric value “3”, “green” is associated with the pen of the numeric value “5”, and “blue” is associated with the pen of the numeric value “9”.

The numeric value information 225 includes information on the target numeric values (answer) set beforehand according to the graphic. One target numeric value is set for one problem (graphic). For example, “3” is set as the target numeric value for graphic 1-1 (see FIG. 4A), and “13” is set as the target numeric value for graphic 4-1 (see FIG. 4B). The target numeric value is determined for example, by making a matrix calculation of the combination of pen numeric values of “1, 2, 4, 9” and all patterns for the color combinations to place in each zone. In the case of graphic 4-1, the combination of colors placed so that the same colors are not adjacent is: [first color, second color, third color, fourth color]=[2, 1, 1, 0] and [1, 1, 1, 1]. The method for determining the target numeric value is not limited to the above described method. The target numeric value determined in this way is associated with the graphic and stored in the table in FIG. 3 as numeric value information 225. Plural target numeric values (answers) may be set for one problem (graphic).

The control part 210 includes control devices such as a CPU, a ROM and a RAM. The CPU is a processor that executes various types of processing. The ROM is a non-volatile storage portion containing pre-stored control programs such as BIOS and OS to execute various types of processing in the CPU. The RAM is a volatile or non-volatile storage portion that stores various types of information; and is utilized as a temporary storage memory (task memory zone) for each process executed by the CPU. The control part 210 controls the controller 200 by executing the various control programs that are stored beforehand in the ROM or the storage portion 220 on the CPU.

More specifically, the control part 210 includes processors such as an input information acquirer 211, a problem submitter 212, a color judger 213, a numeric value judger 214, a correctness judger 215, and a display processor 216. The control part 210 functions as the various types of processors by executing the various types of processing according to the game program on the CPU. Also, all or a portion of the processors contained in the control part 210 may also be electronic circuits. The game program may also be a program operating the plurality of processors as various types of processors.

The input information acquirer 211 acquires information input by user operation on the touch panel display 100. The input information acquirer 211 for example, acquires information (information about the selected level) input by the user on the touch panel 110 when starting the game, and information (information on the selected pen, information on the selected zone) input by the user during the game. For example, information on the numeric value and color information (an example of attribute information in the present invention) associated with the applicable pen is acquired when the user has selected one pen among four pens.

The problem submitter 212 submits a problem associated with the level selected by the user to the user from among the plurality of problems that are stored in the storage portion 220. For example, when the user selects level 4 on the level selection screen shown in FIG. 2A, the problem submitter 212 refers to the problem information 222 (see FIG. 3) and displays graphic 4-1 of the problem associated with level 4, and the target numeric value “13” on the start screen (see FIG. 2B) of the display 120. Also, the problem submitter 212 refers to the problem information 222 and the pen information 224 (see FIG. 7) and displays the red pen assigned the numeric value “2”, the yellow pen assigned the numeric value “3”, the green pen assigned the numeric value “5”, and the blue pen assigned the numeric value “9” on the start screen.

The color judger 213 judges whether or not the color associated with the pen selected by the user, and the color displayed in the zone (equivalent to second zone of the present invention) adjacent to the zone (equivalent to first zone of the present invention) selected by the user with the applicable pen are identical. For example, in the state shown in FIG. 2D, when the user selects the green pen and selects the zone in the lower center, the color judger 213 refers to the adjacent zone list shown in FIG. 5B, and judges whether or not the green color of the pen and the color of the zones (zone A, zone B) adjacent to the zone in the lower center (zone C shown in FIG. 5A) selected by the green pen are identical. Here, the green color of the pen is different from the red color of the zone A and the yellow color of the zone B so the color judger 213 judges that the colors are respectively different. When there are plural adjacent zones, and at least one or any of the colors is the same as the pen color, the color judger 213 judges that the color associated with the pen, and the color of the adjacent zones are identical. For example, in the state shown in FIG. 2D, when the user selects the yellow pen and selects the zone C, the color judger 213 judges that the pen color and the color of the zone B adjacent to the zone C selected by the applicable pen are the same color.

The numeric value judger 214 judges whether or not the total numeric value that is the sum of the numeric values respectively associated with all zones selected by the pen selected by the user and the target numeric value match each other. For example, when the user selects the zone A with the red pen, and selects the zone B and the zone D with the yellow pen, and selects the zone C with the green pen, the numeric value judger 214 calculates the total numeric value “13” by summing the numeric values associated with each of the zones A through D (see FIG. 2F). In this case, the numeric value judger 214 judges that the total numeric value and the target numeric value match each other. Moreover, when the user for example, selects the zone A with the red pen, and selects the zone B with the yellow pen, and selects the zone C with the green pen, and selects the zone D with the blue pen, the numeric value judger 214 sums the numeric values associated with each zone A through D to calculate the total numeric value “19” (see FIG. 2H). In this case, the numeric value judger 214 judges that the total numeric value and the target numeric value do not match each other.

The correctness judger 215 judges the correctness with regard to the problem based on the judgement results from the color judger 213 and the judgement results from the numeric value judger 214. For example, the correctness judger 215 judges incorrectness with regard to the problem when the color associated with the pen selected by the user, and the color displayed in the zone adjacent to the zone selected by the applicable user with the applicable pen are the same color (see FIG. 2G). The correctness judger 215 also judges incorrectness with regard to the problem when the total numeric value and the target numeric value do not match each other (see FIG. 2H). The correctness judger 215 moreover judges correctness with regard to the problem when the colors associated with the respective two adjacent zones are mutually different for all zones contained within the graphic, and the total numeric value and the target numeric value match each other (see FIG. 2F).

The display processor 216 shows various information on the display 120. The display processor 216 for example, displays the level select screen (see FIG. 2A), the start screen (see FIG. 2B), and the game screen during the ongoing game on the display 120. For example, when the user selects the red pen and selects the zone A, the display processor 216 displays the applicable zone A in red and also displays the numeric value “2” associated with the red pen inside the applicable zone A. The display processor 216 also displays the total numeric value that is the sum of the numeric values displayed in each zone on the game screen. When the judgement regarding the problem is determined as correct, the display processor 216 displays a “Correct” image on the game screen, and when the judgement regarding the problem is determined as incorrect, displays an “Incorrect” image on the game screen. When the game ends, the display processor 216 may also display a score screen showing the game results on the display 120. The score screen may also show for example, the time required from the start of the game until achieving a correct answer, past scores, and the current level.

When the judgement is “Correct” with regard to the problem, the control part 210 notifies the user with information (message, voice) that the result is correct. When the judgement is “Incorrect” with regard to the problem, the control part 210 notifies the user with information (message, voice) that the result is incorrect.

The input information acquirer 211 is one example of the pen information acquirer of the present invention. The problem submitter 212 is one example of the problem submitter of the present invention. The color judger 213 is one example of the attribute judger of the present invention. The numeric value judger 214 is one example of the numeric value judger of the present invention. The correctness judger 215 is one example of the correctness judger of the present invention. The display processor 216 is one example of the display processor of the present invention.

### Game Control Process

One example of a procedure for a game control process performed by the control part 210 of the controller 200 is described next while referring to FIG. 8 and FIG. 9. The game control process is one example of the game control method of the present invention. The present invention may be understood as an invention for a game control method that executes one or a plurality of steps included in the game control process.

The game control process starts by the user turning on the power to the game device 1 on the touch panel display 100. The description given here follows the example explained above.

When the user powers-on the game device 1, the control part 210 (display processor 216) displays a level selection screen (FIG. 2A) on the display 120 of the game device 1. When the user selects for example the level 4 on the level selection screen, in step S11, the control part 210 (input information acquirer 211) acquires the selected level 4 information.

In step S12, the control part 210 (problem submitter 212) submits to the user, the problem associated with level 4 selected by the user. More specifically, the control part 210 refers to the problem information 222 (see FIG. 3), and displays graphic 4-1 (see FIG. 4B) and the target numeric value “13” for the problem associated with level 4 on the start screen (see FIG. 2B.) of the display 120. The control part 210 also refers to the problem information 222 and the pen information 224 (see FIG. 7) and displays the red pen assigned a numeric value “2”, a yellow pen assigned a numeric value “3”, a green pen assigned a numeric value “5”, and a blue pen assigned a numeric value “9” on the start screen (see FIG. 2B.). The user selects the desired pen on the start screen.

Next, in step S13, the control part 210 (input information acquirer 211) acquires the pen information selected by the user. For example, when the user selects a red pen, the control part 210 acquires information on the color (“red”) and on the numeric value (“2”) associated with the applicable pen.

Next, in step S14, the control part 210 (input information acquirer 211) acquires information on the zone selected by the user. For example, when the user selects the zone A with the red pen, the control part 210 acquires information on the applicable zone A.

Next, in step S15, the control part 210 (input information acquirer 211) acquires information on the zone adjacent to the zone selected by the user. For example, when the user selects the zone A with the red pen, the control part 210 refers to the adjacent zone list shown in FIG. 5B, and acquires information on the zones B, C, D adjacent to the applicable zone A (see FIG. 5B.).

Next, in step S16, the control part 210 (input information acquirer 211) acquires information on the (displayed) color associated with the adjacent zone. For example, when the user selects the zone A with the red pen on the start screen (see FIG. 2B), the control part 210 acquires information on the “white” color of the zones B, C, and D adjacent to the zone A. Also, in the state shown in FIG. 2D, when the user selects the zone C with the yellow pen, the control part 210 acquires information on the respective “red”, “yellow”, and “white” as the colors of the zones A, B, D adjacent to zone C.

Next, in step S17, the control part 210 (color judger 213) judges whether or not the color associated with the pen selected by the user, and the (displayed) color associated with the zone adjacent to the zone selected by the user with the applicable pen are the same color. If the above mentioned colors are not the same (S17: NO), for example when the color (“red”) of the pen that selects the zone A on the start screen (see FIG. 2B), and the color (“white”) for zone B, C, D are not the same color, the processing shifts to step S19. On the other hand, when the above mentioned colors are the same (S17: YES), for example in the state shown in FIG. 2D, when the color (“yellow”) of the pen that selects the zone C is the same as the color (“yellow”) for one zone (here zone B) among at least any of the zones A, B, D, the processing shifts to step S18.

In step S18, the control part 210 (correctness judger 215) judges incorrectness with regard to the problem, the control part 210 (display processor 216) displays an “Incorrect” image on the display 120 as shown in FIG. 2G. The subsequent processing returns to step S13 and the pen selection by the user is accepted.

In step S19, the control part 210 (display processor 216) displays the zone selected by the user in the pen color selected by the user, and displays the numeric value associated with the applicable pen in the applicable zone. For example, on the start screen (see FIG. 2B) when the user selects the zone A with the red pen, the control part 210 displays the zone A in a red color and displays a numeric value “2” in the zone A as shown in FIG. 2C. Moreover, when the user selects the zone B with the yellow pen in the state shown in FIG. 2C, the control part 210 displays the zone B in yellow color and displays the numeric value “3” in the zone B as shown in FIG. 2D.

Next, in step S20, the control part 210 performs numerical value judgement processing. FIG. 9 is a flowchart showing one example of the procedure of the numerical value judgement processing.

In the numeric value judgement processing, first of all in step S21 shown in FIG. 9, the control part 210 (numeric value judger 214) calculates the total numeric value that is the sum of the numeric values associated with each zone selected by the pen selected by the user. The control part 210 (display processor 216) displays the total numeric value on the game screen of the display 120.

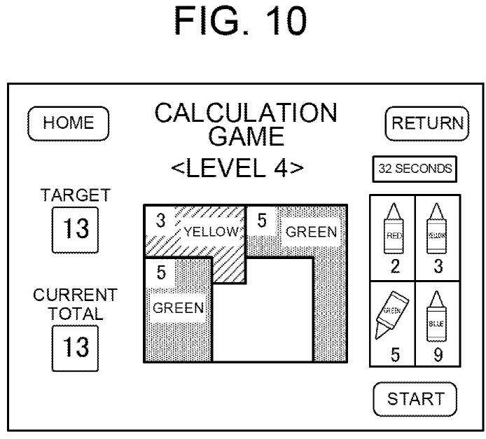

Next, in step S22, the control part 210 judges whether or not there is an unselected zone among the zones contained in the graphic. Namely, the control part 210 judges whether or not there are any unselected zones (zone with default setting color: white) not associated (not displayed) with a pen color selected by the user from among the zones contained in the graphic. When there is an unselected zone (S22: YES) among the zones contained in the graphic, the processing returns to step S13 and the pen selection by the user is accepted. Therefore, even in the case for example shown in FIG. 10, that the user selects the zone D with a green pen and the total numeric value matches the target numeric value, when there is an unselected zone C, the processing returns to step S13 and the pen selection by the user is accepted. When there are no unselected zone among the zones contained in the graphic (S22: NO), the processing proceeds to step S23.

Next, in step S23, the control part 210 (numeric value judger 214) judges whether or not the total numeric value matches the target numeric value. When the total numeric value matches the target numeric value (S23: YES), the processing proceeds to step S24, and when the total numeric value does not match the target numeric value the processing proceeds to step S25.

In step S24, the control part 210 (correctness judger 215) judges correctness with regard to the problem, and the control part 210 (display processor 216) displays the “Correct” image on the display 120 as shown in FIG. 2F. The control part 210 may notify the user with information that the answer is correct. The processing subsequently ends.

In step S25, the control part 210 (correctness judger 215) judges incorrectness with regard to the problem, and the control part 210 (display processor 216) displays the “Incorrect” image on the display 120 as shown in FIG. 2H. The control part 210 may notify the user with information that the answer is incorrect. The processing subsequently returns to step S13 and the pen selection by the user is accepted.

In the above described example of the processing, in step S15, the control part 210 performs processing to acquire all adjacent zones that are adjacent to the zone selected by the user, however, the present invention is not limited to this processing. In other embodiments, the control part 210 may perform processing in steps S15 through S17 to acquire one adjacent zone each that is adjacent to the zone selected by the user.

Therefore, in the game of the game device 1 of the embodiment of the present invention as described above, to simultaneously improve calculating ability and planning ability in a graphic including a plurality of zones; each zone is selected so that two adjacent zones are not the same color and so that the total numeric value is matched with the target numeric value.

The present invention is not limited to the above described embodiments and may be rendered from the embodiments shown below.

In another embodiment, in the game device 1, a numeric value need not be associated with information assigned for each pen color. In this embodiment, for example, when the user selects a pen with numeric value “2” and selects the zone A in the start screen (see FIG. 2B), the control part 210 displays numeric value “2” associate with the zone A while the zone A is unchanged as a white display. Next, when the user selects a pen with numeric value “3” and selects the zone B; the control part 210 judges whether or not the numeric value (one example of attribute information of the present invention) associated with the pen, and the numeric value associated with the zone A adjacent to the zone B match each other. Here, when the numeric value for the pen selected by the user, and the numeric value associated with the zone adjacent to the zone selected by the user are the same, the control part 210 judges that the answer to the problem is incorrect. On the other hand, when in all the zones contained in the graphic, the numeric values associated with each of two adjacent zones are different from each other, and the total numeric value and the target numeric value match each other, the control part 210 judges the answer to the problem is correct.

In this way, the game for the game device 1, in a graphic sub-divided into a plurality of zones, may also be a game that selects a plurality of applicable zones such that the numeric value associated with a selected zone is not the same as an adjacent zone, and also the (displayed) total numeric value associated with each zone matches the target numeric value.

The game device 1 of the present invention can be installed on a user terminal such as a computer, a tablet terminal, or a smartphone. The user can also play the game by downloading and executing the game program stored on a cloud server by way of the user terminal.

In the game device 1 according to the present invention each of the above described embodiments can be freely combined for each aspect within the scope of the invention, or each embodiment may be appropriately modified or a part omitted.

What is claimed is:

1. A game device provided with a display, the game device comprising:
a problem submitter that submits a problem with regard to a graphic sub-divided into a plurality of zones;
a pen information acquirer that acquires attribute information and numeric value information associated with a pen selected by a user from among a plurality of pens;
an attribute judger that judges whether or not the attribute information associated with the pen and acquired by the pen information acquirer is identical to the attribute information associated with a second zone adjacent to a first zone selected by the pen in the graphic;
a numeric value judger that judges whether or not a total numeric value that is the sum of numeric values associated with all of the respective zones selected by the pen, matches a target numeric value associated with the graphic; and
a correctness judger that judges correctness with regard to the problem, based on judgement results from the attribute judger and judgement results from the numeric value judger.

2. The game device according to claim 1,
wherein the attribute information is information showing the color of the pen.

3. The game device according to claim 2, further comprising:
a display processor that displays the color and the numeric value associated with the pen in the zone selected by the pen in the graphic.

4. The game device according to claim 2,
wherein the correctness judger judges incorrectness with regard to the problem when the color associated with the pen and a color displayed in the second zone are the same color.

5. The game device according to claim 2,
wherein the correctness judger judges incorrectness with regard to the problem when the total numeric value and the target numeric value do not match each other.

6. The game device according to claim 2,
wherein the correctness judger judges correctness with regard to the problem when in all zones contained in the graphic, colors respectively associated with two adjacent zones are mutually different colors, and the total numeric value and the target numeric value match each other.

7. The game device according to claim 1,
wherein the attribute information is the numeric value information associated with the pen, and
the correctness judger judges incorrectness with regard to the problem when the numeric value associated with the pen and the numeric value associated with the second zone are the same, whereas judges correctness with regard to the problem when in all zones contained in the graphic, the respective numeric values associated with two adjacent zones are mutually different, and the total numeric value and the target numeric value match each other.

8. A game control method comprising:
submitting a problem with regard to a graphic sub-divided into a plurality of zones;
acquiring attribute information and numeric value information associated with a pen selected by a user from among a plurality of pens;
judging whether or not the attribute information associated with the pen and acquired in the acquisition of the pen information is identical to the attribute information associated with a second zone adjacent to a first zone selected by the pen in the graphic;
judging whether or not a total numeric value that is the sum of the numeric values associated with all of the respective zones selected by the pen, matches a target numeric value associated with the graphic; and
judging correctness with regard to the problem, based on judgement results from the attribute judging and judgement results from the numeric value judging.

9. A non-transitory recording medium storing a game program for causing a computer to execute:
submitting a problem with regard to a graphic sub-divided into a plurality of zones;
acquiring attribute information and numeric value information associated with a pen selected by a user from among a plurality of pens;
judging whether or not the attribute information associated with the pen and acquired in the acquisition of the pen information is identical to the attribute information associated with a second zone adjacent to a first zone selected by the pen in the graphic;
judging whether or not a total numeric value that is the sum of the numeric values associated with all of the respective zones selected by the pen, matches a target numeric value associated with the graphic; and
judging correctness with regard to the problem, based on judgement results from the attribute judging and judgement results from the numeric value judging.
